(19) United States
(12) Patent Application Publication
(10) Pub. No.: US 2024/0331035 A1
(43) Pub. Date: Oct. 3, 2024

(54) SYSTEMS AND METHODS FOR FACILITATING SENSITIVE DATA INTERPRETATION ACROSS DISPARATE SYSTEMS

(71) Applicant: Wells Fargo Bank, N.A., San Francisco, CA (US)

(72) Inventors: Debashis Ghosh, Charlotte, NC (US); Poonam Rao, Charlotte, NC (US); Nadia Van De Walle, Washington, DC (US); Angela Melita Maryland, McLean, VA (US)

(21) Appl. No.: 18/192,458

(22) Filed: Mar. 29, 2023

(51) Int. Cl. G06Q 40/03

(52) U.S. Cl. CPC G06Q 40/03

(57) ABSTRACT

Systems, apparatuses, methods, and computer program products are disclosed for facilitating sensitive data interpretation across disparate systems. An example method includes receiving, by communications hardware, a historical dataset of events having occurred within a first jurisdiction in association with an individual. The example method also includes receiving, by the communications hardware, a request associated with the first individual and a second jurisdiction. The example method also includes receiving, by an assessment engine, a predefined metrics set for the second jurisdiction. The example method also includes determining, by the assessment engine and based on the predefined metrics set, a subset of the historical dataset that is relevant to the second jurisdiction. The example method also includes utilizing, by the assessment engine, the subset of the historical dataset in connection with a credit assessment of the first individual in the second jurisdiction.

### BACKGROUND

Different jurisdictions operate under different methodologies for determining credit scores. For example, some countries may utilize different metrics and/or weigh metrics differently when determining a credit score for an individual.

### BRIEF SUMMARY

Credit scores are numerical values used by financial institutions to determine and assess an individual's creditworthiness. A credit score is a crucial factor in deciding whether an individual qualifies for a financial product, such as a loan, credit card, and/or the like. Various metrics are used to determine a credit score. Some examples of metrics include credit utilization, payment history, credit mix, and length of credit history. However, as noted above, countries each have their own unique underlying methodologies for calculating a credit score or otherwise assessing an individual's creditworthiness. Some countries may not determine actual credit scores, but rather some other form of credit assessment based on a maintained register that tracks credit activity among citizens.

In the United States, for example, credit scores are primarily determined using the FICO® (Fair Isaac Corporation) score model, which considers five metrics to determine creditworthiness: payment history (e.g., how often the individual has made late payments, defaulted on loans, or declared bankruptcy), credit utilization (e.g., an amount of revolving credit used divided by total credit available), length of credit history (e.g., how long an individual has been utilizing credit products and their repayment history), new credit (e.g., recent credit inquiries), and credit mix (e.g., types of credit). Some metrics may be weighted more heavily than others in the determination of a credit score. For instance, payment history may account for 35% of the FICO credit score. In contrast, credit scores in Canada are determined using the Equifax Risk Score model, which places greater emphasis on credit utilization (30% of the credit score). The length of credit history is also another significant factor in Canada, which accounts for 15% of the credit score. These differences are just a few examples of how countries utilize their own particular methodologies in assessing credit.

Existing credit score translation products that aim to translate a credit score from one country to another exhibit limitations to the detriment of the individual utilizing those products. For instance, there is no standard credit score that applies globally; credit scoring models vary widely across countries, with each country having its own credit reporting system and methodologies for determining credit assessments. As a result, credit score translation products may not accurately reflect an individual's creditworthiness in a country that the individual is attempting to apply for credit in. In this regard, different countries have different attitudes towards credit and financial responsibility, which may impact how credit scores are determined.

Additionally, credit score translation products may not have access to a complete credit report, which can limit their ability to provide an accurate credit score. To compound this issue, some credit bureaus in certain countries may not be willing to provide credit reports to third-party companies, making it difficult for these products to provide an accurate translation.

Further, credit score translation products may not fully realize local credit practices in certain countries, which can impact the accuracy of a credit score translation in the new country. For instance, local credit practices such as the role of cosigners, use of collateral, and/or credit evaluation processes vary between countries and can affect the final credit score translation if not properly taken into account.

Additionally, existing products and services around credit score translation and credit assessment in general fail to provide safeguards for transmission of sensitive data between various institutions. In this regard, operations related to credit assessment require a great deal of sensitive information related to finances and personally identifiable information (PII) about an individual and this information is often left vulnerable to exposure in its provision to third-party systems and the like.

In contrast to these conventional techniques, example embodiments described herein provide unified credit assessment system that allows for portability of credit-related information across different jurisdictions and re-creation of a credit assessment in another jurisdiction in which the individual has little or no credit history. Example embodiments leverage a historical dataset of financial information about an individual in addition to predefined metrics sets and credit assessment methodologies unique to particular jurisdictions to provide a re-creation of a credit assessment (such as a credit score) for a second jurisdiction. In this regard, even though an individual may not have a credit history in a second jurisdiction, financial event data of the individual within the first jurisdiction can be leveraged to provide an accurate and verifiable re-creation of the credit assessment for the second jurisdiction.

Example embodiments may identify metrics of credit and enable identification of relevant data based on these metrics for processing by various credit decision-makers in a format necessitated by the credit bureaus in that country. These metrics may be individual characteristics that are known to be used as a basis for credit decision-making in one or more countries. For each universal indicator of credit, example embodiments may identify the manner and nature by which that universal indicator of credit is used by the credit bureau in each country (or if it is not used in that country). As such, constituent information about an individual may be used to “rebuild” a credit score in a target country based on data captured from another country.

Additionally, example embodiments may utilize enhanced security measures to avoid exposure of personally identifiable information (PII) of an individual to third parties. To do this, example embodiments may utilize biometric security as a required authentication procedure before allowing access to a credit assessment or to any PII. Additionally, or alternatively, in some embodiments, access may be metered to just that information that is needed for a credit decision. In some embodiments, the system may operate in a double-blind fashion, such that a credit decision-maker may not actually receive any of the underlying PII forming the basis of a credit determination in another country but may simply get access to a synthetic dataset having been generated based on authentic data related to the individual. Similarly, the identity of the individual in question might also be protected from view, such that a tourist or traveler can remain anonymous in the jurisdiction while still having access to credit. In one implementation, an individual can be verified via a biometric on file with their bank when traveling abroad while remaining anonymous to the government, thus allowing them to perform transactions or participate in activities requiring a credit assessment.

Accordingly, the present disclosure sets forth systems, methods, and apparatuses that facilitate sensitive data interpretation across disparate systems to allow an individuals to be more efficiently recognized in jurisdictions in which they possess little to no credit history. In this regard, example embodiments provide a system that acts as an intermediary between organizations (such as credit bureaus, financial institutions, and/or the like) in various countries around the world and facilitates the establishment of credit for individuals to participate in credit-based transactions across the globe.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2A illustrates a schematic block diagram of example circuitry embodying a system device that may perform various operations in accordance with some example embodiments described herein.

FIG. 2B illustrates a schematic block diagram of example circuitry embodying a remote device or client device that may perform various operations in accordance with some example embodiments described herein.

FIG. 3 illustrates an example flowchart for facilitating sensitive data interpretation across disparate systems, in accordance with some example embodiments described herein.

FIG. 4 illustrates an example flowchart for utilizing a subset of a historical dataset in connection with a credit assessment of an individual, in accordance with some example embodiments described herein.

FIG. 5 illustrates an example flowchart for facilitating performance of an action by an individual requiring a credit assessment, in accordance with some example embodiments described herein.

FIG. 6 illustrates another example flowchart for facilitating performance of an action by an individual requiring a credit assessment, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

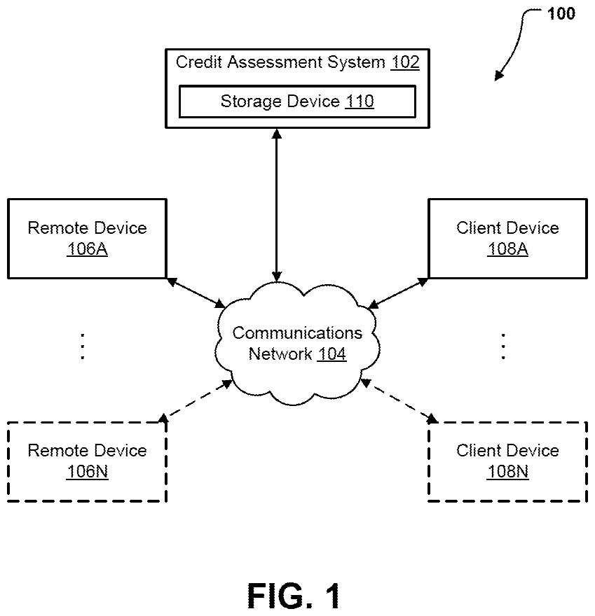

Example embodiments described herein may be implemented using any of a variety of computing devices or servers. To this end, FIG. 1 illustrates an example environment 100 within which various embodiments may operate. As illustrated, a credit assessment system 102 may receive and/or transmit information via communications network 104 (e.g., the Internet) with any number of other devices, such as one or more of remote devices 106A-106N and/or client devices 108A-108N.

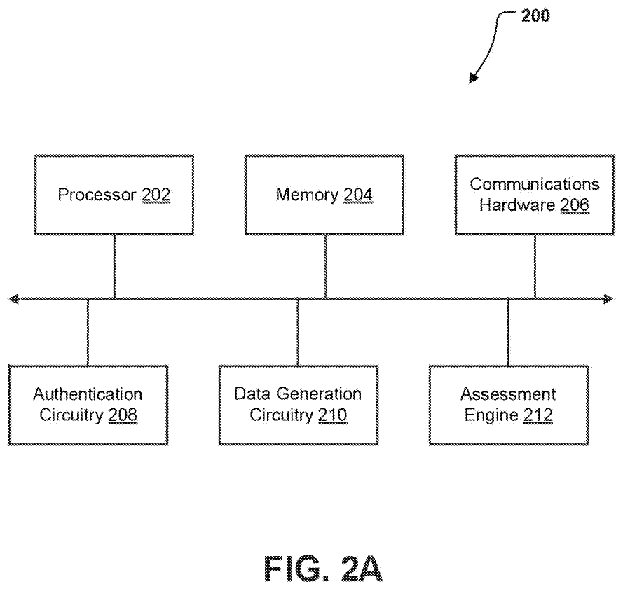

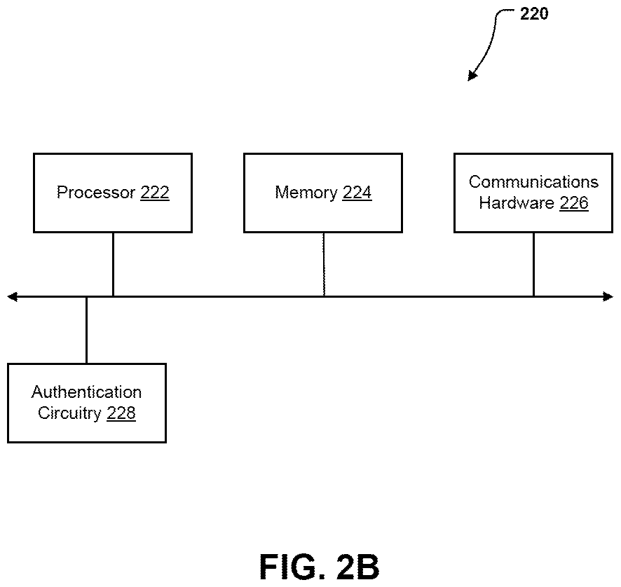

The credit assessment system 102 may be implemented as one or more computing devices or servers, which may be composed of a series of components. Particular components of the credit assessment system 102 are described in greater detail below with reference to apparatus 200 in connection with FIG. 2A.

In some embodiments, the credit assessment system 102 further includes a storage device 110 that comprises a distinct component from other components of the credit assessment system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the credit assessment system 102. Storage device 110 may store information relied upon during operation of the credit assessment system 102, such as various predefined metrics sets that may be used by the credit assessment system 102, data and documents to be analyzed using the credit assessment system 102, or the like. In addition, storage device 106 may store control signals, device characteristics, and access credentials enabling interaction between the credit assessment system 102 and one or more of the remote devices 106A-106N or client devices 108A-108N.

The one or more remote devices 106A-106N and the one or more client devices 108A-108N may be embodied by any computing devices known in the art. The one or more remote devices 106A-106N and the one or more client devices 108A-108N need not themselves be independent devices, but may be peripheral devices communicatively coupled to other computing devices. In some embodiments, remote devices 106A-106N may comprise devices that are associated with certain entities such as merchants, financial institutions (e.g., banks, credit unions, etc.), rental companies, and/or the like. For instance, a remote device 106A-106N of an entity may interact with the credit assessment system 102 in order to obtain a credit assessment for an individual attempting to obtain a credit product from the entity. For instance, the individual may be visiting a country and need to rent a car, which may require a credit assessment of the individual. As another example, the individual may have recently emigrated to a new country and need to obtain a loan for certain expenses.

In some embodiments, remote devices 106A-106N may also comprise devices associated with various financial institutions, credit bureaus, and/or similar organizations that may feed data to the credit assessment system 102. For example, various remote devices 106A-106N may provide historical datasets associated with individuals to the credit assessment system 102. In some embodiments, a plurality of financial institutions (e.g., banks, credit unions, credit bureaus, and/or other financial institutions) may partner together and/or agree to provide information, such as historical datasets, to the credit assessment system 102, e.g., in order to participate in a more unified credit assessment system that allows for portability of credit-related information across different jurisdictions.

In some embodiments, client devices 108A-108N may be personal devices that belong to or are otherwise associated with individuals. For instance, a client device may be a mobile phone, laptop, desktop computer, smartwatch or other wearable device, or the like. In some embodiments, an individual may utilize their client device to communicate with the credit assessment system 102 and/or one or more remote devices 106A-106N. For example, an individual may utilize their personal client device to send a request to the credit assessment system 102 to facilitate a credit assessment for the individual with respect to a particular jurisdiction (e.g., a particular country or region). In some examples, an individual may utilize their personal client device to send data indicative of a credit assessment to one or more remote devices (e.g., when attempting to obtain a credit product from an entities associated with the one or more remote devices).

Particular components of the remote devices 106A-106N and client devices 108A-108N are described in greater detail below with reference to apparatus 220 in connection with FIG. 2B.

### Example Implementing Apparatuses

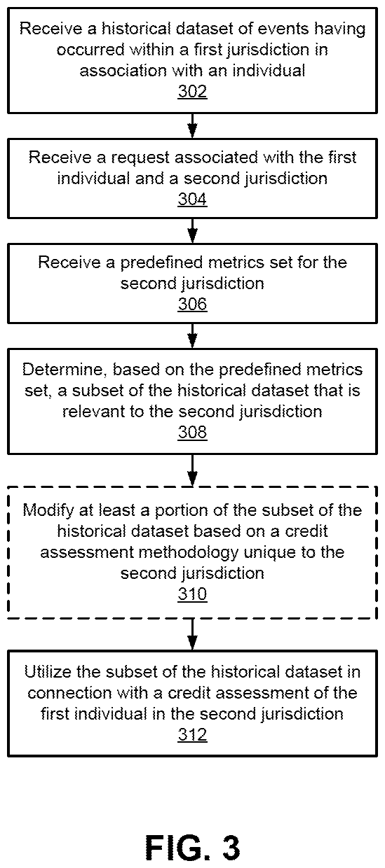

The credit assessment system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-5. As illustrated in FIG. 2A, the apparatus 200 may include processor 202, memory 204, communications hardware 206, authentication circuitry 208, data generation circuitry 210, and an assessment engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

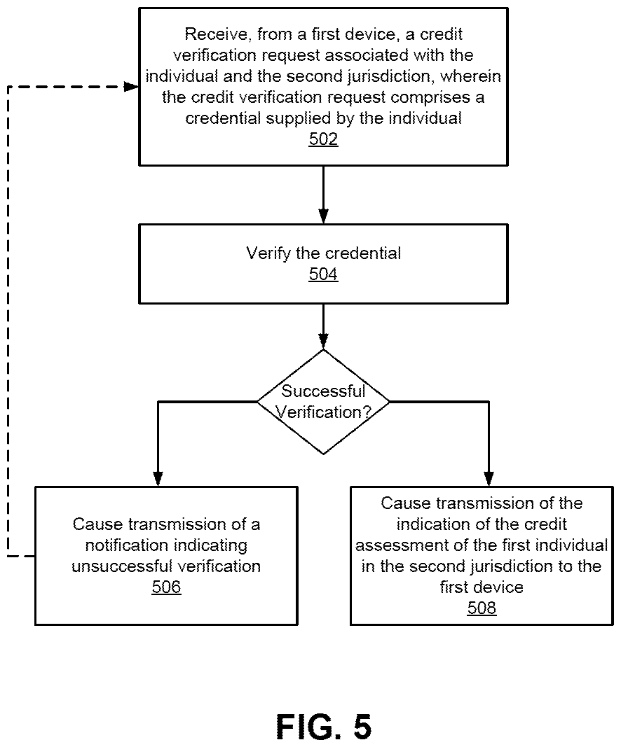

In addition, the apparatus 200 further comprises authentication circuitry 208 that verifies credentials of individuals. In some embodiments, a credential may comprise a biometric marker, unique identification code, secret question and answer combination, and/or the like. The authentication circuitry 208 may utilize processor 202, memory 204, or any other hardware component included in the apparatus 200 to perform these operations, as described in connection with FIG. 5 below. The authentication circuitry 208 may further utilize communications hardware 206 to gather data from a variety of sources (e.g., remote devices 106A-106N, client devices 108A-108N, and/or storage device 110, as shown in FIG. 1), and/or exchange data with a user, and in some embodiments may utilize processor 202 and/or memory 204 to verify a credential.

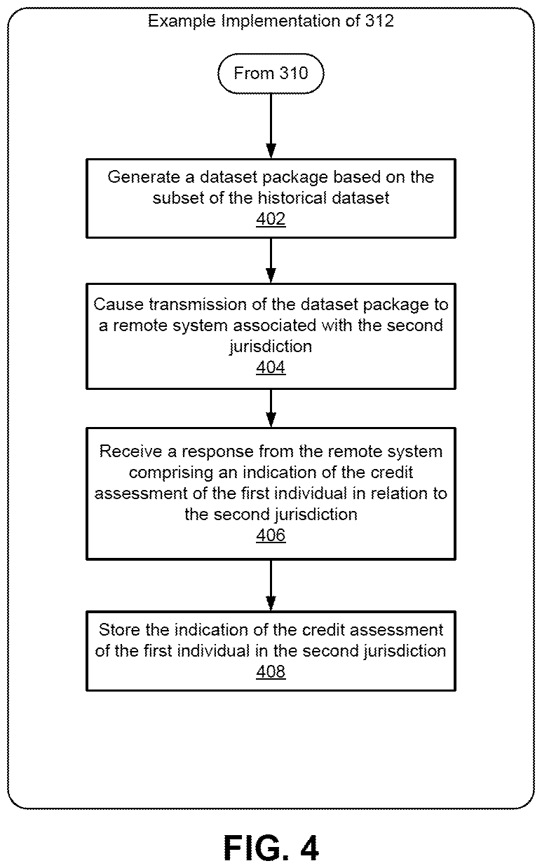

In addition, the apparatus 200 further comprises data generation circuitry 210 that generates a dataset package based on at least a subset of a historical dataset. In some embodiments, the data generation circuitry 210 may generate a dataset package by generating a synthetic dataset based at least on a subset of a historical dataset. In this regard, the synthetic dataset may be generated to comprise synthetic data that anonymizes authentic data of the subset of the historical dataset. The data generation circuitry 210 may utilize processor 202, memory 204, or any other hardware component included in the apparatus 200 to perform these operations, as described in connection with FIGS. 3 and 4 below. The data generation circuitry 210 may further utilize communications hardware 206 to gather data from a variety of sources (e.g., BBB 106A-106N or CCC 108A-108N, as shown in FIG. 1), and/or exchange data with a user, and in some embodiments may utilize processor 202 and/or memory 204 to generate a dataset package.

Further, the apparatus 200 further comprises an assessment engine 212 that determines, based on a predefined metrics set, a subset of a historical dataset that is relevant to a particular jurisdiction and utilizes the subset of the historical dataset in connection with a credit assessment of an individual in the particular jurisdiction. In some embodiments, the assessment engine 212 may utilize the subset of the historical dataset in conjunction with a credit assessment methodology unique to the particular jurisdiction to determine a credit assessment (e.g., a credit score or other indication of credit worthiness) for an individual in the particular jurisdiction. The assessment engine 212 may utilize processor 202, memory 204, data generation circuitry 210, or any other hardware component included in the apparatus 200 to perform these operations, as described in connection with FIGS. 3 and 4 below. The assessment engine 212 may further utilize communications hardware 206 to gather data from a variety of sources (e.g., remote devices 106A-106N or client devices 108A-108N, and/or storage device 110, as shown in FIG. 1), and/or exchange data with a user, and in some embodiments may utilize processor 202 and/or memory 204 to determine, based on a predefined metrics set, a subset of the historical dataset that is relevant to a particular jurisdiction, and/or utilize a subset of the historical dataset in connection with a credit assessment of an individual in a particular jurisdiction.

Although components 202-212 are described in part using functional language, it will be understood that the particular implementations necessarily include the use of particular hardware. It should also be understood that certain of these components 202-212 may include similar or common hardware. For example, the authentication circuitry 208, data generation circuitry 210, and assessment engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the authentication circuitry 208, data generation circuitry 210, and assessment engine 212 may leverage processor 202, memory 204, or communications hardware 206 as described above, it will be understood that any of authentication circuitry 208, data generation circuitry 210, and assessment engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that authentication circuitry 208, data generation circuitry 210, and assessment engine 212 comprise particular machinery designed for performing the functions described herein in connection with such elements of apparatus 200.

As illustrated in FIG. 2B, an apparatus 220 is shown that represents an example remote device (e.g., any of remote devices 110A-110N) or an example client device (e.g., any of client devices 108A-108N). The apparatus 220 includes a processor 222, memory 224, communications hardware 226, and authentication circuitry 228, each of which is configured to be similar to the similarly named components described above in connection with FIG. 2A.

In some embodiments, various components of the apparatuses 200 and 220 may be hosted remotely (e.g., by one or more cloud servers) and thus need not physically reside on the corresponding apparatus 200 or 220. For instance, some components of the apparatus 200 may not be physically proximate to the other components of apparatus 200. Similarly, some or all of the functionality described herein may be provided by third party circuitry. For example, a given apparatus 200 or 220 may access one or more third party circuitries in place of local circuitries for performing certain functions.

As will be appreciated based on this disclosure, example embodiments contemplated herein may be implemented by an apparatus 200 or 220. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2A or apparatus 220 as described in FIG. 2B, that loading the software instructions onto a computing device or apparatus produces a special-purpose machine comprising the means for implementing various functions described herein.

Having described specific components of example apparatuses 200 and 220, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-5 may, for example, be performed by system device of the credit assessment system 102 shown in FIG. 1, which may in turn be embodied by an apparatus 200, which is shown and described in connection with FIG. 2A. To perform the operations described below, the apparatus 200 may utilize one or more of processor 202, memory 204, communications hardware 206, authentication circuitry 208, data generation circuitry 210, assessment engine 212, and/or any combination thereof. It will be understood that user interaction with the credit assessment system 102 may occur directly via communications hardware 206, or may instead be facilitated by a separate client device 108A-108N or remote device 106A-106N, as shown in FIG. 1, which may have similar or equivalent physical componentry facilitating such user interaction.

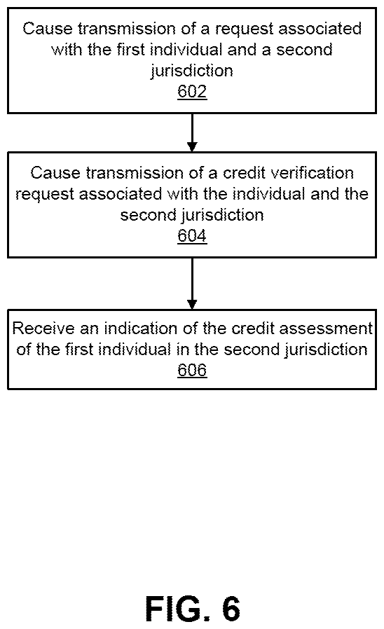

Meanwhile, the various operations described in connection with FIG. 6 may be performed by apparatus 220, which may utilize one or more of processor 222, memory 224, communications hardware 226, authentication circuitry 228, and/or any combination thereof.

Turning first to FIG. 3, example operations are shown for facilitating sensitive data interpretation across disparate systems.

As shown by operation 302, the apparatus 200 includes means, such as processor 202, memory 204, communications hardware 206, or the like, for receiving a historical dataset of events having occurred within a first jurisdiction in association with an individual.

As noted above, in some embodiments, the credit assessment system 102 may operate in connection with a plurality of financial institutions and/or similar organizations to provide a unified and verifiable means for porting pertinent data (e.g., credit-related data and other financial data) across different disparate systems (e.g., computing systems of financial institutions, credit bureaus, and/or other similar organizations) in different jurisdictions. In this regard, in some embodiments, a plurality of financial institutions may operate in connection with the credit assessment system 102 in that the financial institutions may provide data to the credit assessment system 102. In some embodiments, data may be provided to the credit assessment system 102 automatically and periodically, such that the credit assessment system 102 receives data from various financial institutions automatically and on a regular basis. In some embodiments, data may be provided to the credit assessment system 102 on-demand, e.g., in response to a request from the credit assessment system 102 to one or more financial institutions or the like.

In some embodiments, the credit assessment system 102 may receive a historical dataset of events having occurred within a first jurisdiction in association with an individual. The events may include financial-related events that correspond to various metrics which may be used in determining a credit score or other type of credit assessment, as well as other financial events related to the individual. For example, an event may comprise a payment made on a loan or other credit product. In this regard, historical data related to that particular event may comprise data indicating whether the payment was made on time, a date and/or time of the payment, a means for making the payment, the type of credit product involved, a specific product or service for which the payment was needed, and/or other related information. In some examples, a historical dataset may comprise data related to events such as purchases made over specific periods of time using credit products, which together may indicate a credit utilization percentage for the individual. In some examples, a historical dataset may comprise information on types of credit associated with the individual (e.g., various loans, credit cards, and/or other credit accounts that the individual has opened). In general, a historical dataset for an individual may comprise sensitive financial data regarding the individual that may be pertinent to assessing credit worthiness of the individual in any jurisdiction. In some embodiments, the events associated with the historical dataset may be events having occurred within a first jurisdiction in association with the individual. In this regard, the events having occurred may have occurred within the individual's home country. For example, a historical dataset for an individual residing in the United States may contain data regarding events having taken place in the United States.

As noted above, the historical dataset may be received by the credit assessment system 102 automatically and periodically. In this regard, the credit assessment system 102 may receive the historical dataset at a given time or day in connection with a predefined schedule. For example, the credit assessment system 102 may be configured to automatically receive a historical dataset from one or more financial institutions once every 24 hours. In this regard, a historical dataset may comprise multiple historical datasets of an individual originating from multiple financial institutions.

In some embodiments, a historical dataset may be received by the credit assessment system 102 in response to a request generated by the credit assessment system 102 and transmitted to one or more financial institutions. In this regard, the apparatus 200 includes means, such as processor 202, memory 204, communications hardware 206, or the like, for causing transmission of a request for a historical dataset. The request may be transmitted to one or more remote devices (e.g., any of remote devices 106A-106N) associated with one or more financial institutions in order to obtain a historical dataset.

In some embodiments, the request may be transmitted in response to a request received by the credit assessment system 102. For instance, an individual may request (e.g., via a client device) that the credit assessment system 102 begin facilitating a generation of a credit assessment for the individual with respect to a particular jurisdiction. As shown by operation 304, the apparatus 200 includes means, such as processor 202, memory 204, communications hardware 206, or the like, for receiving a request associated with the first individual and a second jurisdiction.

The request may be received in response to the individual needing to obtain a credit assessment for themselves with respect to a second jurisdiction (different from a first jurisdiction, e.g., a jurisdiction in which they have historically lived). For example, the individual may be traveling or moving to a second jurisdiction and thus need to perform an action within the second jurisdiction that requires a credit assessment. However, as the individual has not yet built credit within the second jurisdiction, the individual may be unable to participate in such activities. For example, it may be difficult or impossible for the individual to obtain a loan, credit card, or other credit product within the second jurisdiction because existing credit in other jurisdictions conventionally does not carry over to new jurisdictions, therefore it may appear to financial institutions or other organizations within the second jurisdiction that the individual has no credit (or insufficient credit). To alleviate these issues, the individual may utilize the credit assessment system 102 in order to facilitate a re-creation of their credit standing from the first jurisdiction within the second jurisdiction.

As shown by operation 306, the apparatus 200 includes means, such as processor 202, memory 204, communications hardware 206, or the like, for receiving a predefined metrics set for the second jurisdiction. A predefined metrics set comprises a data structure indicating various categories of metrics that are taken into account when determining a credit assessment in a particular jurisdiction. For instance, a predefined metrics set for the United States would include categories such as payment history, credit utilization, length of credit history, new credit, and credit mix. In some embodiments, a predefined metrics set may define a set of metrics for determining a credit score within a country. In some embodiments, a predefined metrics set may additionally or alternatively define a set of metrics for a specific organization with a particular jurisdiction. For instance, while a credit score may be calculated only from information in an individual's credit report, certain lenders may ascertain many metrics when making a credit decision which do not necessarily correspond to conventional metrics for determining a credit score, such as, for example, the individual's income, how long an individual has worked at their current job, and/or other metrics.

In some embodiments, the communications hardware 206 may receive a predefined metrics set from a memory (e.g., memory 204 and/or storage device 110). In this regard, the credit assessment system 102 may store a plurality of predefined metrics set based on its knowledge of various jurisdictions and/or organizations within those jurisdictions. These predefined metrics sets may be provided (e.g., automatically, periodically, and/or upon request) to the credit assessment system 102 by organizations within the various jurisdictions, such as credit bureaus, financial institutions, certain lenders, and/or the like.

In some embodiments, the predefined metrics set for the second jurisdiction may be received in response to a metrics request for the predefined metrics set generated by the credit assessment system 102 and transmitted to one or more remote devices (e.g., any of remote devices 106A-106N) within the second jurisdiction. The metrics request may comprise an electronic query that is generated and transmitted to the one or more remote devices in response to the credit assessment system 102 receiving the request associated with the first individual and the second jurisdiction (as discussed above in connection with operation 304). In this regard, in some embodiments, the credit assessment system 102 may ensure that it has the most recent metrics information related to a credit assessment in order to fully and accurately process the request provided by the individual.

As shown by operation 308, the apparatus 200 includes means, such as processor 202, memory 204, assessment engine 212, or the like, for determining, based on the predefined metrics set, a subset of the historical dataset that is relevant to the second jurisdiction. As noted above, the historical dataset may contain a wealth of financial data related to the individual. However, not all of this data may be relevant to determining a credit assessment of the individual with respect to the second jurisdiction. In this regard, some data of the historical dataset may not fit into one of the categories of metrics defined in the predefined metrics set, and therefore may be determined to be irrelevant to a determination of a credit assessment for the individual in the second jurisdiction.

To preserve computational resources and eliminate irrelevant data from being considered in a credit assessment determination, the assessment engine 212 may determine a subset of data from the historical dataset that most likely pertains to the categories defined in the predefined metrics set. To do so, the assessment engine 212 may apply various categorization techniques to data points of the historical dataset.

As one example, the assessment engine 212 may utilize a machine learning (ML) model to determine whether a financial data point (e.g., a data point related to a financial event as discussed above) fits into one or more of the categories defined in the predefined metrics set. For example, the credit assessment engine 212 may utilize a ML model trained on labeled data that is categorized according to various categories including those defined in the predefined metrics set. In this regard, in its training, the ML model may learn to associate certain features or patterns of data points with certain categories. Once trained, the ML model can be used to classify new financial data points into one or more of the categories defined in the predefined metrics set based on its learned associations. For instance, the ML model may analyze the features of patterns in a given data point of the historical dataset and determine a likelihood that is belongs in each category. In some embodiments, the likelihood may be represented as a percent likelihood, or, e.g., as a number between 0 and 1, with a number closer to 1 indicating a greater likelihood that the data point belongs to the respective category. For example, for a data point meeting a likelihood threshold (e.g., greater than or equal to 0.70) for a category, the assessment engine may determine that the data point is to be included in the subset of the historical dataset.

In some embodiments, the subset of the historical dataset may optionally be modified to some degree based on a credit assessment methodology used by the particular jurisdiction for which the subset of the historical dataset is based on. In this regard, as shown by operation 310, the apparatus 200 includes means, such as processor 202, memory 204, assessment engine 212, or the like, for modifying at least a portion of the subset of the historical dataset based on a credit assessment methodology unique to the second jurisdiction. A credit assessment methodology may comprise a dataset and/or algorithm that indicates a process and/or set of criteria that is used by a particular financial institution, lender, or the like, to evaluate a creditworthiness of an individual. In this regard, while a predefined metrics set identifies which relevant categories of metrics for a particular jurisdiction, the credit assessment methodology defines how to use the relevant data to determine a credit assessment within the particular jurisdiction. For example, in some embodiments, a credit assessment methodology may apply weighted values to various data points based on their association with certain categories of the predefined metrics set. For instance, a credit methodology for the United States may involve applying greater weight to data points related to events that are likely to correspond to payment history than data points related to other categories (as payment history may account for 35% of the FICO credit score in the United States).

In some embodiments, modifying data within subset of the historical dataset based on a credit assessment methodology may involve scaling certain data within the subset of the historical dataset. For instance, certain data from one jurisdiction may need to be scaled in order to meet the needs of another jurisdiction. As one example, if debt-to-income (DTI) ratios are different in two countries, an individual's data may be scaled relative to their peers in one country for use in the other country. For example, if the individual is in the 50^{th} percentile for DTI in the United States, the data to be used when determining a credit assessment for China should be the 50^{th} percentile.

Some approaches to modifying the subset of the historical dataset may involve using a standardized metric or index that adjusts for differences in economic conditions and currency exchange rates. For example, the World Bank's Purchasing Power Parity (PPP) index may be used to adjust income levels or other financial data points for difference sin the cost of living across jurisdictions. In some embodiments, the assessment engine 212 may utilize benchmarking or comparative analysis techniques to compare an individuals DTI financial data of a first jurisdiction to similar individuals in the second jurisdiction. To do so, for instance, the credit assessment system 102 may collect and analyze data on DTI ratios and other relevant financial data points for a representative sample of individuals in the second jurisdiction and compare the individual's financial data to the sample. In some embodiments, another statistical approach, such as z-score normalization can be used to compare the individual's financial data (e.g., DTI ratios or the like) to a distribution of financial data for a similar population in the second jurisdiction. This may involve determining the standard deviation for the target population (e.g., with respect to DTI ratios) and then scaling the person's ratio relative to the distribution.

As shown by operation 312, the apparatus 200 includes means, such as processor 202, memory 204, communications hardware 206, data generation circuitry 210, assessment engine 212, or the like, for utilizing the subset of the historical dataset in connection with a credit assessment of the first individual in the second jurisdiction.

In some embodiments, utilizing the subset of the historical dataset may comprise determining a credit assessment for the individual. In this regard, the credit assessment can be determined by the credit assessment system 102 itself. In doing so, the credit assessment system 102 can re-create a credit score (or similar credit assessment) from a first jurisdiction in a second jurisdiction that is likely to be accurate, given the historical dataset of financial data pertaining to the individual, the predefined metrics set outlining relevant categories of metrics for determining a credit assessment in the second jurisdiction, and the specific and unique credit assessment methodology used (e.g., by organizations) within the second jurisdiction to determine a credit assessment. In this regard, the apparatus 200 includes means, such as processor 202, memory 204, assessment engine 212, or the like, for determining, by the assessment engine and based on the subset of the historical dataset and a credit assessment methodology unique to the second jurisdiction, the credit assessment for the first individual in the second jurisdiction.

In some embodiments, rather than determining a credit assessment itself, the credit assessment system 102 may instead provide data to a remote system, which may in turn determine a credit assessment based on the given data and return the credit assessment to the credit assessment system 102. The remote system may comprise one or more remote devices associated with certain organizations (e.g., a credit bureau, financial institution, lender, or the like) that are associated with the second jurisdiction. In this regard, the credit assessment system 102 may provide the data it has determined to be relevant (e.g., the subset of the historical dataset including any modifications made thereto) to an entity within the second jurisdiction to obtain a truly accurate credit assessment of the individual within the second jurisdiction (based on their financial activities within the first jurisdiction). In this regard, turning to FIG. 4, example operations are shown for utilizing a subset of a historical dataset in connection with a credit assessment of an individual by interacting with one or more remote systems.

As shown by operation 402, the apparatus 200 includes means, such as processor 202, memory 204, communications hardware 206, data generation circuitry 210, assessment engine 212, or the like, for generating a dataset package based on the subset of the historical dataset. In some embodiments, the dataset package may comprise the subset of the historical dataset (e.g., which may have been modified by the credit assessment system 102 as discussed above in connection with operation 310). In this regard, the dataset package may contain all relevant information needed to appropriately determine a credit assessment in the second jurisdiction.

In some embodiments, the credit assessment engine 212 may perform additional steps to ensure that the individual's sensitive data (e.g., contained in the subset of the historical dataset) is protected when generating the dataset package. For example, an individual may desire to not share sensitive and personal financial data with a foreign country, however, may still need to have a credit assessment determined for them in the foreign country. To alleviate this issue, the credit assessment system 102 may generate synthetic data to anonymize data within the subset of the historical dataset. In this regard, the apparatus 200 includes means, such as processor 202, memory 204, data generation circuitry 210, or the like, for generating a synthetic dataset based on the subset of the historical dataset. The synthetic dataset may comprise synthetic data that anonymizes authentic data (e.g., real data points associated with real events that may identify the individual) of the subset of the historical dataset. Said differently, the synthetic dataset may comprise algorithmically generated data points that closely resemble the authentic data points of the subset of the historical dataset without exposing any sensitive information about the individual.

As one example, synthetic data points may be generated based on financial data points related to a vehicle loan in that the synthetic data points may indicate that the individual possesses or has possessed a vehicle loan, but do not identify the actual make, model, or type of vehicle (e.g., the synthetic data points may substitute in a similar make, model, or type of vehicle and not the identify the actual make, model, or type of vehicle). In generating a synthetic dataset, the dataset package may comprise the synthetic dataset such that the determination of a credit assessment for the individual may be performed (e.g., by a remote system) using the synthetic dataset.

As shown by operation 404, the apparatus 200 includes means, such as processor 202, memory 204, communications hardware 206, or the like, for causing transmission of the dataset package to a remote system associated with the second jurisdiction. As noted above, the remote system may comprise one or more remote devices (e.g., any of remote devices 106A-106N) that may be associated with one or more financial institutions, credit bureaus, lenders, and/or other similar organizations within the second jurisdiction which may determine a credit assessment for the individual based on the information contained in the dataset package.

As shown by operation 406, the apparatus 200 includes means, such as processor 202, memory 204, communications hardware 206, or the like, for receiving a response from the remote system comprising an indication of the credit assessment of the first individual in relation to the second jurisdiction. For example, the response may comprise an indication of the credit assessment of the first individual in that the response may comprise a determined credit score for the individual within the second jurisdiction.

As shown by operation 408, the apparatus 200 includes means, such as processor 202, memory 204, communications hardware 206, or the like, for storing the indication of the credit assessment of the first individual in the second jurisdiction. For example, the credit assessment system 102 may store the indication of the credit assessment of the first individual in a memory (e.g., storage device 110, memory 204, and/or the like). The credit assessment may be stored in order to efficiently retrieve the credit assessment at a later time, e.g., when the individual may need to supply a credit assessment in order to perform an action within the second jurisdiction.

Turning now to FIG. 5, example operations are shown for facilitating performance of an action by an individual requiring a credit assessment. In some embodiments, for example, the individual may travel within (or emigrate to) the second jurisdiction and may need to perform an action that requires a credit assessment within the second jurisdiction. For example, a traveler may need to rent a vehicle for a weekend within the second jurisdiction. As another example, an individual who is planning to move to the second jurisdiction may need to apply for an apartment. Each of these actions may require a credit assessment of the individual (e.g., the lender in each scenario would need to assess the individual's credit score). In contrast to convention implementations wherein the lender might run a credit check on the individual only to find that the individual has little or no credit (e.g., due to having built credit in the first jurisdiction and not having built credit in the second jurisdiction), the individual may instead utilize the credit assessment system 102 to provide the credit assessment associated with the individual and the second jurisdiction to the lender or other appropriate entity. To do so, the individual may initiate a credit verification request with the credit assessment system 102 in order to gain access to their credit assessment.

As shown by operation 502, the apparatus 200 includes means, such as processor 202, memory 204, communications hardware 206, or the like, for receiving, from a first device, a credit verification request associated with the individual and the second jurisdiction. In some embodiments, the credit verification request comprises a credential supplied by the individual. For example, the credential may comprise a biometric marker of the individual. The individual may supply a biometric marker (or other credential) in order to authenticate themselves to the credit assessment system 102 and obtain access to their credit assessment for the second jurisdiction.

As shown by operation 504, the apparatus 200 includes means, such as processor 202, memory 204, communications hardware 206, authentication circuitry 210, or the like, for verifying the credential. In some embodiments, such as instances in which the credential is a biometric marker (e.g., a fingerprint), the credit assessment system 102 may confirm that the submitted credential shares enough similarities to a stored biometric marker to satisfy a predefined similarity threshold. For example, the authentication circuitry 210 may preprocess the submitted biometric marker (e.g., to remove noise, inconsistencies, or the like) and compare the preprocessed biometric marker to the stored biometric marker using a matching algorithm, such as minutiac-based matching or pattern matching. A resulting match score may then be compared with a predefined similarity threshold. In some embodiments, if the match score exceeds the predefined similarity threshold, the credential may be successfully verified.

As shown in FIG. 5, if the credential cannot be successfully verified, the method may continue to operation 506, wherein the apparatus 200 includes means, such as processor 202, memory 204, communications hardware 206, or the like, for causing transmission of a notification indicating an unsuccessful verification of the credential. The notification may be transmitted back to the device from which the digital withdrawal request originated (e.g., a client device 108A-108N belonging to the individual, or a remote device 106A-106N). In this regard, the notification may prompt the individual to resubmit their credential (e.g., due to a possible bad reading of a biometric or the like).

In response to a successful verification of the credential, the method may continue to operation 508, wherein the apparatus 200 includes means, such as processor 202, memory 204, communications hardware 206, or the like, for causing transmission of the indication of the credit assessment of the first individual in the second jurisdiction to the first device. In this regard, causing transmission of the indication of the credit assessment may facilitate a performance, by the individual, of an action within the second jurisdiction requiring the credit assessment. For instance, the credit assessment may be presented (e.g., displayed) at the remote device or client device such that the individual and/or other entities may view the credit assessment. For example, the credit score of the individual within the second jurisdiction may be displayed. In some embodiments, the indication of the credit assessment may be masked or otherwise omit certain data regarding the credit assessment. For instance, rather than displaying an actual credit score, the indication may comprise a color-coded indication of the credit assessment. For instance, a green colored icon (e.g., a checkmark or the like) may indicate that the individual's credit assessment satisfies certain requirements related to the action for which the credit verification request was initiated, whereas a red colored icon may indicate that the individual's credit assessment does not satisfy the requirements.

Continuing with the discussion of facilitating performance of an action by an individual requiring a credit assessment, FIG. 6 shows example operations which may be performed by an apparatus 220, e.g., a remote device (e.g., any of remote devices 106A-106N) or a client device (e.g., any of client devices 108A-108N) in connection with the operations performed by the as shown in FIG. 5.

As shown by operation 602, the apparatus 220 includes means, such as processor 222, memory 224, communications hardware 226, authentication circuitry 228, or the like, for causing transmission of a request associated with the first individual and a second jurisdiction. This operation may be performed, e.g., by a client device associated with the individual (e.g., in response to the individual needing to obtain a credit assessment for themselves with respect to a second jurisdiction (different from a first jurisdiction), as discussed above in connection with operation 304 of FIG. 3.

As shown by operation 604, the apparatus 220 includes means, such as processor 222, memory 224, communications hardware 226, or the like, for causing transmission of a credit verification request associated with the individual and the second jurisdiction. For example, as discussed above in connection with operation 502 of FIG. 5, in some embodiments, an individual may initiate a credit verification request with the credit assessment system 102 via their client device in order to gain access to a credit assessment stored by the credit assessment system 102. In some alternative embodiments, the credit verification request may be transmitted by a remote device 106A-106N, such as a device associated with a financial institution, lender, or the like that the individual is interacting with. As discussed above, in some embodiments, the credit verification request comprises a credential supplied by the individual. For example, the individual may utilize a fingerprint reader on their client device to submit a credential in connection with the credit verification request.

As shown by operation 606, the apparatus 220 includes means, such as processor 222, memory 224, communications hardware 226, or the like, for receiving an indication of the credit assessment of the first individual in the second jurisdiction. In this regard, the individual may then utilize the credit assessment to prove adequate creditworthiness to an entity, such as a financial institution, lender, or the like, in order to perform some action requiring a credit assessment for the individual in the second jurisdiction.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved facilitation of sensitive information and data interpretation over disparate systems. Example embodiments thus provide tools that overcome the problems faced by individuals when traveling abroad or emigrating to new countries. As discussed above, example embodiments limit the exposure of sensitive data by enabling credit decisioning based on synthetic data that anonymizes authentic financial data of individuals. Further, example embodiments solve issues exhibited by existing credit “translation” services by providing a more accurate reflection of credit in various jurisdictions through working in connection with financial organizations of the various jurisdictions to maintain an up-to-date set of metrics and credit assessment methodologies. By doing so, a credit score is not merely “translated,” but rather re-created from a realistic foundation of metrics and methodologies necessary to render an accurate credit assessment for a given jurisdiction. Further, accuracy of a credit assessment is enhanced by the modification of historical data to meet the needs of certain jurisdictions (e.g., by way of data scaling or the like).

As these examples all illustrate, example embodiments contemplated herein provide technical solutions that solve real-world problems faced by individuals needing to render a credit assessment in a jurisdiction in which they have little or no credit history. Example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, a historical dataset of events having occurred within a first jurisdiction in association with an individual;
receiving, by the communications hardware, a request associated with the first individual and a second jurisdiction;
receiving, by an assessment engine, a predefined metrics set for the second jurisdiction;
determining, by the assessment engine and based on the predefined metrics set, a subset of the historical dataset that is relevant to the second jurisdiction; and
utilizing, by the assessment engine, the subset of the historical dataset in connection with a credit assessment of the first individual in the second jurisdiction.

2. The method of claim 1, wherein utilizing the subset of the historical dataset comprises:
determining, by the assessment engine and based on the subset of the historical dataset and a credit assessment methodology unique to the second jurisdiction, the credit assessment for the first individual in the second jurisdiction.

3. The method of claim 1, further comprising:
modifying, by the assessment engine, at least a portion of the subset of the historical dataset based on the credit assessment methodology unique to the second jurisdiction.

4. The method of claim 2, wherein determining the credit assessment comprises:
determining, by the assessment engine and based at least on the subset of the historical dataset and the credit assessment methodology unique to the second jurisdiction, a credit score for the first individual in the second jurisdiction.

5. The method of claim 1, wherein utilizing the subset of the historical dataset comprises:
generating, by data generation circuitry, a dataset package based on the subset of the historical dataset; and
causing transmission, by the communications hardware, of the dataset package to a remote system associated with the second jurisdiction, wherein causing transmission of the dataset package to the remote system associated with the second jurisdiction facilitates a determination of the credit assessment of the first individual in the second jurisdiction.

6. The method of claim 5, wherein generating the dataset package comprises:
generating, by the data generation circuitry, a synthetic dataset based on the subset of the historical dataset, wherein the synthetic dataset comprises synthetic data that anonymizes authentic data of the subset of the historical dataset,
wherein the dataset package comprises the synthetic dataset such that the determination of the credit assessment of the first individual is performed using the synthetic dataset.

7. The method of claim 5, further comprising:
receiving, by the communications hardware, a response from the remote system comprising an indication of the credit assessment of the first individual in relation to the second jurisdiction; and
storing, by the communications hardware, the indication of the credit assessment of the first individual in the second jurisdiction.

8. The method of claim 7, further comprising:
receiving, by the communications hardware and from a first device, a credit verification request associated with the individual and the second jurisdiction, wherein the credit verification request comprises a credential supplied by the individual;
verifying, by authentication circuitry, the credential; and
in response to a successful verification of the credential, causing transmission, by the communications hardware, of the indication of the credit assessment of the first individual in the second jurisdiction to the first device, wherein causing transmission of the indication of the credit assessment facilitates performance, by the individual, of an action within the second jurisdiction requiring the credit assessment.

9. The method of claim 8, wherein the credential comprises a biometric marker of the individual.

10. The method of claim 1, wherein the first jurisdiction comprises a first country and the second jurisdiction comprises a second country different from the first country.

11. An apparatus comprising:
communications hardware configured to:
receive a historical dataset of events having occurred within a first jurisdiction in association with an individual, and
receive a request associated with the first individual and a second jurisdiction; and
an assessment engine configured to:
receive a predefined metrics set for the second jurisdiction;
determine, based on the predefined metrics set, a subset of the historical dataset that is relevant to the second jurisdiction; and
utilize the subset of the historical dataset in connection with a credit assessment of the first individual in the second jurisdiction.

12. The apparatus of claim 11, wherein the assessment engine is configured to utilize the subset of the historical dataset by:
determining, based on the subset of the historical dataset and a credit assessment methodology unique to the second jurisdiction, the credit assessment for the first individual in the second jurisdiction.

13. The apparatus of claim 11, wherein the assessment engine is further configured to:
modify at least a portion of the subset of the historical dataset based on the credit assessment methodology unique to the second jurisdiction.

14. The apparatus of claim 12, wherein the assessment engine is configured to determine the credit assessment by:
determining, based at least on the subset of the historical dataset and the credit assessment methodology unique to the second jurisdiction, a credit score for the first individual in the second jurisdiction.

15. The apparatus of claim 11, further comprising data generation circuitry configured to generate a dataset package based on the subset of the historical dataset; and
wherein the communications hardware is further configured to cause transmission of the dataset package to a remote system associated with the second jurisdiction,
wherein causing transmission of the dataset package to the remote system associated with the second jurisdiction facilitates a determination of the credit assessment of the first individual in the second jurisdiction.

16. The apparatus of claim 15, wherein the data generation circuitry generates the dataset package by:
generating a synthetic dataset based on the subset of the historical dataset,
wherein the synthetic dataset comprises synthetic data that anonymizes authentic data of the subset of the historical dataset, and
wherein the dataset package comprises the synthetic dataset such that the determination of the credit assessment of the first individual is performed using the synthetic dataset.

17. The apparatus of claim 15, wherein the communications hardware is further configured to:
receive a response from the remote system comprising an indication of the credit assessment of the first individual in relation to the second jurisdiction, and
store the indication of the credit assessment of the first individual in the second jurisdiction.

18. The apparatus of claim 17, wherein the communications hardware is further configured to receive, from a first device, a credit verification request associated with the individual and the second jurisdiction, wherein the credit verification request comprises a credential supplied by the individual; and
wherein the apparatus further comprises authentication circuitry configured to verify the credential; and
wherein the communications hardware is further configured to, in response to a successful verification of the credential, cause transmission of the indication of the credit assessment of the first individual in the second jurisdiction to the first device,
wherein causing transmission of the indication of the credit assessment facilitates performance, by the individual, of an action within the second jurisdiction requiring the credit assessment.

19. The apparatus of claim 18, wherein the credential comprises a biometric marker of the individual.

20. The apparatus of claim 11, wherein the first jurisdiction comprises a first country and the second jurisdiction comprises a second country different from the first country.
